(19) United States
(12) Patent Application Publication
(10) Pub. No.: US 2024/0018387 A1
(43) Pub. Date: Jan. 18, 2024

(54) BUILDING MATERIALS AND METHODS OF PREPARATION THEREOF

(71) Applicant: WESTLAKE ROYAL ROOFING LLC, Houston, TX (US)

(72) Inventors: Edward F. CASSIDY, Corpus Christi, TX (US); Russell L. HILL, San Antonio, TX (US); Robert W. SHUGDINIS, Simsbury, CT (US); Xi ZHANG, Mechanicsburg, PA (US); Ying ZHANG, Wildwood, MO (US)

(73) Assignee: WESTLAKE ROYAL ROOFING LLC, Houston, TX (US)

(21) Appl. No.: 18/253,847

(22) PCT Filed: Nov. 23, 2021
(86) PCT No.: PCT/US2021/060529

§ 371 Date: May 22, 2023

Related U.S. Application Data
(60) Provisional application No. 63/117,211, filed on Nov. 23, 2020.

(51) Int. Cl. C09D 175/06; B29D 99/00; B29C 44/18; C08G 18/42; C08G 18/76; C08J 9/14; C08J 9/00; C08K 3/36; C09D 5/02; C09D 7/61; E04C 2/26; E04C 2/30

(52) U.S. Cl. CPC C09D 175/06; B29D 99/0021; B29C 44/186; C08G 18/4208; C08G 18/7671; C08J 9/141; C08J 9/0066; C08K 3/36; C09D 5/021; C09D 7/61; E04C 2/26; E04C 2/30; B29L 2031/608

(57) ABSTRACT

Building materials that include a structure such as a structural support are described, wherein the structure defines a plurality of cavities at least partially filled with a polymeric foam. The polymeric foam may include a hydrophobic polyurethane foam having a density less than 5 pcf and/or the structure may include a hydrophobic polymer.

### CROSS-REFERENCE TO RELATED APPLICATION

This application claims priority to U.S. Provisional Application No. 63/117,211, filed on Nov. 23, 2020, which is incorporated herein by reference in its entirety.

### TECHNICAL FIELD

The present disclosure generally relates to composite materials, and methods of use and preparation thereof.

### BACKGROUND

Polymeric structural composites are useful for various applications due to their physicochemical properties. Yet, such composites may add undesirable weight and/or density to building materials and structures. Current composites also may provide insufficient durability to different environmental conditions.

### SUMMARY

The present disclosure includes building materials and methods of making building materials. For example, the present disclosure includes a building material comprising a structure have a plurality of cavities and a polymeric foam filing a portion of the plurality of cavities, wherein the polymeric foam comprises hydrophobic polyurethane foam having a density less than 5 pcf, and wherein the structure comprises a hydrophobic polymer. A sample of the composite material having a length of 6 inches may have a moisture movement of less than or equal to 1.0% along the length when submerged in 46° C. distilled water for 10 days and/or a water uptake of less than 20.0 wt % when submerged in 46° C. distilled water for 10 days.

According to sample examples herein, the structure may have a thickness of about 0.10 mm to about 100 mm. The polymeric foam may comprise an inorganic filler. The cavities of the structure may have a circular or polygonal shape. In some examples, the composite material may have a generally rectangular shape with a thickness of about 0.25-3 inches.

The present disclosure also includes a building material comprising a structure having a plurality of cavities, the structure comprising a first polymeric foam and a second polymeric foam that fills the plurality of cavities, wherein the composite material has an average density less than 20 pcf and/or a compressive strength of at least 60 psi. In some examples, each of the first polymeric foam and the second polymeric foam may be hydrophobic and/or the first polymeric foam may have a different chemical composition than the second polymeric foam. In at least one example, the second polymeric foam has a density less than 5 pcf A surface of the building material may comprise a layer of a waterproof sealant, a layer of a cementitious material, a polymeric facer, or a combination thereof.

The present disclosure also includes a method of preparing building materials. For example, the method may comprise preparing a structure having a plurality of cavities, the structure comprising a first polymeric material; and covering the structure with a polymer mixture comprising a blowing agent, such that the polymer mixture foams to fill the cavities with a second polymeric material; wherein the building material has an average density less than 15 pcf. The polymer mixture may comprise, for example, a polyester polyol derived from phthalic anhydride; phthalic acid; isophthalic acid; terephthalic acid; methyl esters of phthalic, isophthalic, or terephthalic acid; dimethyl terephthalate; polyethylene terephthalate; trimellitic anhydride; pyromellitic dianhydride; maleic anhydride; or mixtures thereof. In some examples, the polymer mixture comprises monomeric methylene diphenyl diisocyanate. Optionally, the polymer mixture comprises monomeric methylene diphenyl diisocyanate and polymeric methylene diphenyl diisocyanate. In some examples, the polymer mixture further comprises a surfactant and a catalyst. The method may further comprise preparing the polymer mixture by combining monomeric methylene diphenyl diisocyanate with a hydrophobic polyol to produce a prepolymer mixture, and then combining the prepolymer mixture with the blowing agent. The prepolymer mixture may have a viscosity of 5,000 cps to 15,000 cps. The structure may be covered with the polymer mixture in a closed mold.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIGS. 1A-1E show exemplary support structures, according to some aspects of the present disclosure.

FIG. 2 shows an exemplary support structure, polymeric foam, and composite material, according to some aspects of the present disclosure.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±5% of a specified amount or value. All ranges are understood to include endpoints, e.g., a molecular weight between 250 g/mol and 1000 g/mol includes 250 g/mol, 1000 g/mol, and all values between.

The present disclosure generally includes building materials, e.g., composite materials, comprising a structure, also referred to herein as a structural support, and methods of preparing such building materials. For example, the building materials herein may comprise a structure having a plurality of cavities at least partially filled with a polymeric foam. The structure/structural support and/or polymeric foam may confer water resistance and/or strength to the building and composite materials. The building materials herein may have a relatively low density and a compressive strength sufficient for use in various applications. The mechanical properties of the building materials may allow for their use in place of other materials such as lumber, plywood, particle board, and other wood- or fiber-based materials.

The structural supports (structures) of the composite materials herein define a plurality of cavities. The cavities may be defined by one or more surfaces of the structural support. The term cavities includes, for example, voids in any form such as indentations in an upper surface, lower surface, and/or side surface of the structural support, as well as through-holes, apertures, or passages extending through the structural support.

The cavities of the structural support may have various shapes, such as a circular shape (circular cross-section) or polygonal shape (polygonal cross-section), e.g., rectangular, pentagonal, hexagonal, etc. For example, the structural support may have a three-dimensional (3D) shape such as a honeycomb structure (e.g., including one or more through-holes), a waffle-like structure (e.g., including one or more indentations), a corrugated structure, or a zigzag structure (e.g., including one or more indentations). Further, for example, the structural supports herein may have a polygonal shape (e.g., square, rectangular, triangular, rhomboidal, trapezoidal, cubic, etc.), a curved shape (e.g., oval, circular, etc.) or a combination thereof, wherein the structural support may define a plurality of cavities, such as one or more through-holes, indentations, or a combination thereof. In some examples, the structural support may have a repeating configuration forming a plurality of cavities of substantially the same shape and/or substantially the same volume. In at least one example, the structural support defines a plurality of cavities on an upper surface, a lower surface, or both an upper surface and a lower surface of the structural support. In at least one example, the structural support has a porous structure, e.g., defining one or more cavities in the form of apertures extending between an upper surface and a lower surface of the structural support.

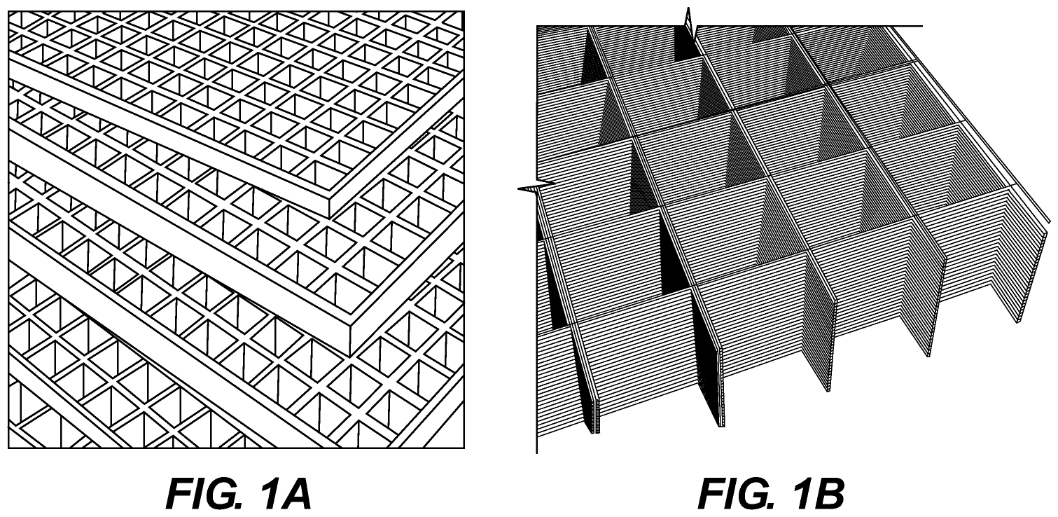

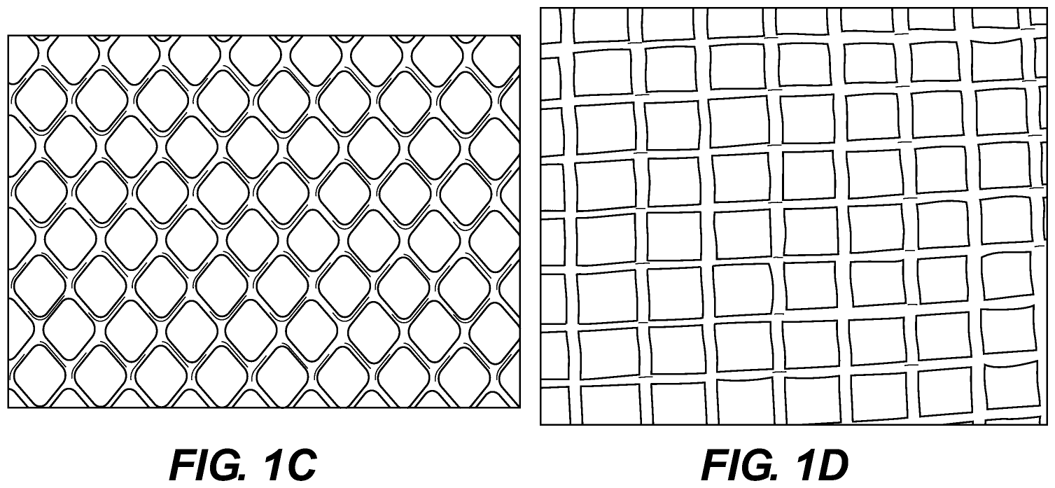

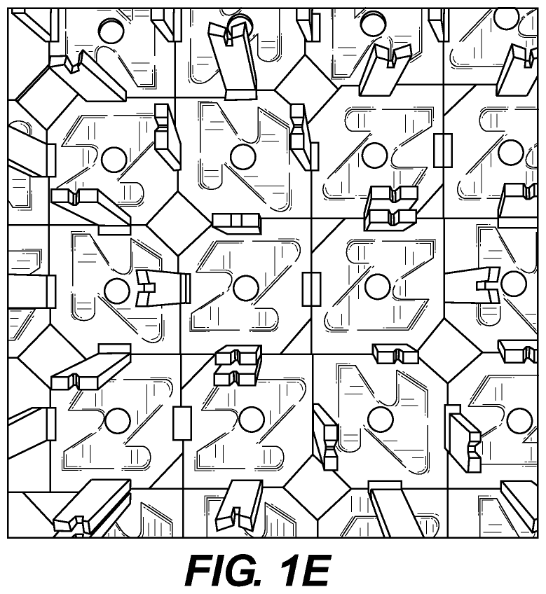

FIGS. 1A-1E show several examples of structural supports that may be used in the building materials herein. FIG. 1A shows structural supports with a plurality of square-shaped cavities aligned in rows and columns, wherein the cavities are in the form of through-holes. In other examples, a structural support of the type depicted in FIG. 1A may define cavities in the upper surface and the lower surface of the structural support, similar to a waffle. In such cases, the structural support does not include through-holes. FIG. 1B shows an exemplary structural support with square-shaped cavities in the form of through-holes, wherein the structural support is formed from multiple support components stacked or otherwise coupled together. In this example, each support component has the same width and length, and the total thickness of the support structure is defined by the sum of the thickness of each support component. FIG. 1C shows an exemplary structural support with a plurality of rhomboidal cavities in the form of through-holes. The rhomboidal cavities are arranged in a regularly repeating pattern. FIG. 1D is similar to FIG. 1C but defines square-shaped cavities.

The types of support structures shown in FIGS. 1A-1D are generally symmetric with respect to x-, y-, and z-planes. FIG. 1E shows an exemplary support structure symmetric about x- and y-planes, but lacking symmetry about the z-plane. Additionally, the structural support in FIG. 1E defines cavities of different sizes and shapes (e.g., square, triangular, circular). The support structure includes a generally planar structure with projections, e.g., pillars, extending from the upper surface.

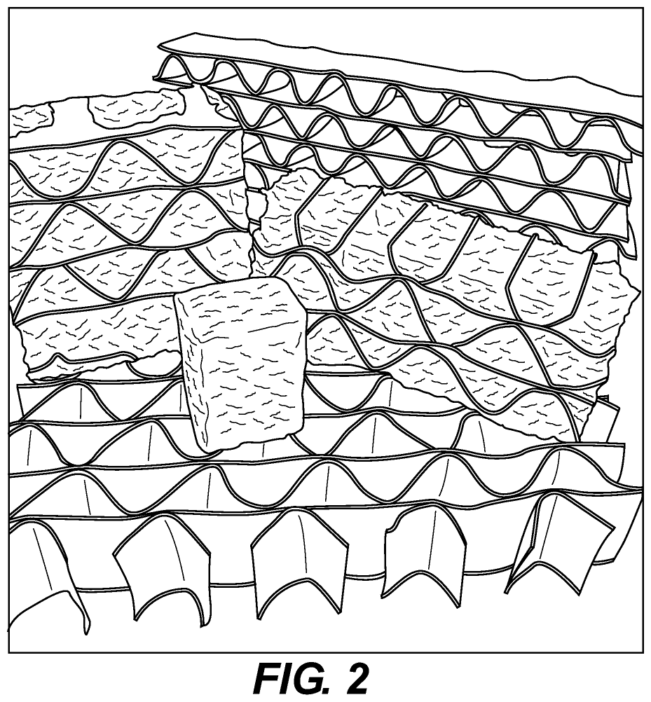

FIG. 2 shows another example of a support structure, as well as polymeric foam and a composite or other building material comprising the support structure and polymeric foam. In FIG. 2, the exemplary support structure has a plurality of triangular cavities in the form of through-holes. The triangular cavities are arranged in a regularly repeating pattern.

In some examples of the present disclosure, the structural support, as a whole, has a thickness less than or equal to 100 mm, that is, the thickness of the material configured into the 3D shape is less than or equal to 100 mm. For example, the thickness may be about 0.1 mm to about 100 mm, such as 0.1 mm to 80 mm, 0.2 mm to 75 mm, 0.25 mm to 65 mm, 1 mm to 25 mm, 1 mm to 5 mm, 2 mm to 10 mm, 5 mm to 20 mm, 10 mm to 40 mm, 15 mm to 30 mm, 50 mm to 65 mm, 7 mm to 15 mm, 20 mm to 30 mm, 10 mm to 15 mm, or 0.1 mm to 10 mm, 60 mm to 100 mm, or 40 mm to 55 mm. In some examples, the thickness of the structural support may be uniform or substantially uniform (e.g., varying less than 5%). Further, the structural support may have a zigzag or honeycomb-like structure, wherein the cavities of the structural support are formed by walls having the same or substantially the same thickness, wherein the thickness of the walls forming the cavities is different from the thickness of the structural support, as a whole. The thickness of the structural support and the thickness of the walls forming the cavities may be present in a ratio ranging from 1:1 to 100:1 (sheet thickness:cavity wall thickness). For example, the ratio of sheet thickness to wall thickness may be 1:1 to 50:1, 1:1 to 25:1, or 1:1 to 10:1. In at least one example, the thickness of the structural support is 20 mm to 50 mm, and the thickness of the walls forming the cavities is 0.5 mm to 5 mm. (i.e., a ratio of sheet thickness:cavity wall thickness of 4:1 to 100:1).

The structural support may comprise a single material or combination of materials. For example, the structural support may comprise one or more polymers (optionally in the form of a foam), fibers, metals, or a combination thereof. Exemplary materials suitable for the structural supports herein include, but are not limited to, paper, cardboard, fiberglass, glass fiber, carbon fiber, aramid fiber, polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, aluminum, and combinations thereof. The structural support may be pre-formed or formed in-situ with one or more polymeric materials. In some examples, the structural support comprises a polymer foam, including a filled polymer foam. The density of a structural support comprising a polymer foam may be less than or equal to 20 lb/ft³ (pcf), such as 1 pcf to 20 pcf, 5 pcf to 10 pcf, or 1 pcf to 10 pcf. In some examples, the density of the structural support is less than or equal to 5 pcf or less than or equal to 2 pcf Optionally, the structural support may include a water-resistant or waterproof coating. For example, the coating may comprise a polymer, e.g., a hydrophobic polymer. Exemplary polymers that may be used in a water-resistant or waterproof coating include fluorinated polymers, polyurethane, polyvinylchloride, polypropylene, polyethylene, polyethylene terephthalate, polyamide, polystyrene, acrylonitrile butadiene styrene, polycarbonate, polyethylenimine, and combinations thereof.

The composite materials herein include a polymeric material in the form of a foam at least partially filling the cavities of the structural support. While the following discussion refers to exemplary materials that may be used to prepare a polymeric foam for combination with the structural support, it is understood that the same materials may be used for the structural support, which may be foamed or unfoamed.

Exemplary polymers suitable for use in the polymeric foams include, but are not limited to, polyurethane, polyvinylchloride, polypropylene, polyethylene, polyethylene terephthalate, polyamide, polystyrene, acrylonitrile butadiene styrene, polycarbonate, polyethylenimine, or a combination thereof. For example, a polymeric foam may be prepared with a chemical or physical blowing agent. In some examples, the polymeric foam consists of or consists essentially of one or more polymers, e.g., polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, or a combination thereof. In some examples, the polymeric foam comprises a polymer and a filler, and optionally other components such as a fiber material.

In some examples, the polymeric foam comprises polyurethane, e.g., prepared by foaming a mixture comprising an isocyanate and a polyol or mixture of polyols. Isocyanates suitable for use in preparing the polymeric foams herein may include at least one monomeric or oligomeric poly- or di-isocyanate. The monomeric or oligomeric poly- or di-isocyanates include aromatic diisocyanates and polyisocyanates. The particular isocyanate used in the mixture may be selected based on the desired viscosity of the mixture used to produce the polymeric material and/or composite materials. For example, a low viscosity may be desirable for ease of handling and transporting. Other factors that may influence the particular isocyanate can include the overall properties of the polymeric material and/or composite materials, such as the amount of foaming, strength of bonding to a functional filler, wetting of inorganic fillers in the mixture, strength of the resulting composite, stiffness (elastic modulus), and reactivity. A consideration when manufacturing polymeric foams, including polyurethane foams, is timing of the mixing of polyols, water, auxiliary/physical blowing agent(s) and isocyanate and the subsequent gelling reactions, foaming reactions and hardening steps. For example, controlling the pace of reactions to allow sufficient capture of evolved gas(es) (e.g., CO₂ in the case of water, gaseous blowing agent in the case of auxiliary/physical blowing agent) may allow for controlling density of the material. The present disclosure includes methods of using mixtures of different isocyanates and/or use of a prepolymer to assist in controlling reactions involved in forming a polymeric foam, e.g., providing for better capture of evolved gases and lower density materials.

In some examples, the polymeric foam is prepared from methylene diphenyl diisocyanate (MDI), which may be present as polymeric MDI, monomeric (pure) MDI (e.g., monomeric 4,4′-MDI), or both. Suitable MDIs include MDI monomers, MDI oligomers, and mixtures thereof. In at least one example, the polymeric foams wherein are prepared with a combination of monomeric MDI and polymeric MDI. Further examples of useful isocyanates include those having NCO (i.e., the reactive group of an isocyanate) contents ranging from about 25% to about 35% by weight. Suitable examples of aromatic polyisocyanates include 2,4- or 2,6-toluene diisocyanate, including mixtures thereof p-phenylene diisocyanate; tetramethylene and hexamethylene diisocyanates; 4,4-dicyclohexylmethane diisocyanate; isophorone diisocyanate; 4,4-phenylmethane diisocyanate; polymethylene polyphenylisocyanate; and mixtures thereof. In addition, triisocyanates may be used, for example, 4,4,4-triphenylmethane triisocyanate; 1,2,4-benzene triisocyanate; polymethylene polyphenyl polyisocyanate; methylene polyphenyl polyisocyanate; and mixtures thereof. Suitable blocked isocyanates are formed by the treatment of the isocyanates described herein with a blocking agent (e.g., diethyl malonate, 3,5-dimethylpyrazole, methylethylketoxime, and caprolactam). In some embodiments, the isocyanate compositions used to form the composite can include those having viscosities ranging from 25 to 700 cPs at 25° C. The average functionality of isocyanates useful with the polyurethane composites described herein can be from 1.5 to 5, such as from 2 to 4.5, from 2.2 to 4, from 2.4 to 3.7, from 2.6 to 3.4, or from 2.8 to 3.2.

The polymeric material may comprise at least one polyol, which may be in liquid form. For example, liquid polyols having relatively low viscosities generally facilitate mixing. Suitable polyols include those having viscosities of 6000 cP or less at 25° C., such as a viscosity of 150 cP to 5000 cP, 250 cP to 4500 cP, 500 cP to 4000 cP, 750 cP to 3500 cP, 1000 cP to 3000 cP, or 1500 cP to 2500 cP at 25° C. Further, for example, the polyol(s) may have a viscosity of 5000 cP or less, 4000 cP or less, 3000 cP or less, 2000 cP or less, 1000 cP or less, or 500 cP or less at 25° C.

The polyol(s) useful for the polymeric materials herein may include compounds of different reactivity, e.g., having different numbers of primary and/or secondary hydroxyl groups. In some embodiments, the polyols may be capped with an alkylene oxide group, such as ethylene oxide, propylene oxide, butylene oxide, and combinations thereof, to provide the polyols with the desired reactivity. In some examples, the polyols can include a poly(propylene oxide) polyol including terminal secondary hydroxyl groups, the compounds being end-capped with ethylene oxide to provide primary hydroxyl groups.

The polyol(s) useful for the present disclosure may have a desired functionality. For example, the functionality of the polyol(s) may be 7.0 or less, e.g., 1.0 to 7.0, or 2.5 to 5.5. In some examples, the functionality of the polyol(s) may be 6.5 or less, 6.0 or less, 5.5 or less, or less, 4.5 or less, 4.0 or less, 3.5 or less, 3.0 or less, 2.5 or less, and/or 1.0 or greater, 2.0 or greater, 2.5 or greater, 3.0 or greater, 3.5 or greater, 4.0 or greater, 4.5 or greater, or 5.0 or greater. The average functionality of the polyols useful for the shapeable composites herein may be 2.5 to 5.5, 3.0 to 5.5, 3.0 to 5.0, 3.0 to 4.5, 2.5 to 4.0, 2.5 to 3.5, or 3.0 to 4.0.

The polyol(s) useful for the polymeric material herein may have an average molecular weight of 250 g/mol or greater and/or 1500 g/mol or less. For example, the polyol(s) may have an average molecular weight of 300 g/mol or greater, 400 g/mol or greater, 500 g/mol or greater, 600 g/mol or greater, 700 g/mol or greater, 800 g/mol or greater, 900 g/mol or greater, 1000 g/mol or greater, 1100 g/mol or greater, 1200 g/mol or greater, 1300 g/mol or greater, or 1400 g/mol or greater, and/or 1500 g/mol or less, 1400 g/mol or less, 1300 g/mol or less, 1200 g/mol or less, 1100 g/mol or less, 1000 g/mol or less, 900 g/mol or less, 800 g/mol or less, 700 g/mol or less, 600 g/mol or less, 500 g/mol or less, 400 g/mol or less, or 300 g/mol or less. In some cases, the one or more polyols have an average molecular weight of 250 g/mol to 1000 g/mol, 500 g/mol to 1000 g/mol, or 750 g/mol to 1250 g/mol.

The polyols useful for the polyurethane composites herein may have a desired hydrophobicity. For example, the backbone structure of the polyol, e.g., the carbon chain length, may affect the relative hydrophobicity of a given polyol. Hydrophobicity may be increased when hydrocarbon chain moieties become an integral part of the backbone structure of the polyol and corresponding composite polymeric materials. Hydrophobicity is generally greater for longer chain lengths (e.g., long aliphatic chains of fatty acid polyols), the absence of ester bonds (hydrolyzable functional groups), and fewer ether oxygen atoms. Without being bound by theory, it is believed that polyols with relatively higher hydrophobicity may provide for higher water resistance and/or less moisture sensitivity during curing with isocyanates for increased durability of the final polyurethane system. Hydrophobic polyols may be aromatic, and/or may originate from bio-based sources such as natural oils.

Polyols useful for the polymeric materials herein include, but are not limited to, aromatic polyols, polyester polyols, poly ether polyols, Mannich polyols, and combinations thereof. Exemplary aromatic polyols include, for example, aromatic polyester polyols, aromatic polyether polyols, and combinations thereof. Exemplary polyester and poly ether polyols useful in the present disclosure include, but are not limited to, glycerin-based polyols and derivatives thereof, polypropylene-based polyols and derivatives thereof, and poly ether polyols such as ethylene oxide, propylene oxide, butylene oxide, and combinations thereof that are initiated by a sucrose and/or amine group. Mannich polyols are the condensation product of a substituted or unsubstituted phenol, an alkanolamine, and formaldehyde. Examples of Mannich polyols that may be used include, but are not limited to, ethylene and propylene oxide-capped Mannich polyols. Polyester polyols suitable for use in the polyurethane composites described herein can have a viscosity at 25° C. that is less than 6000 cP, less than 5000, less than 4000 cP, less than 3000 cP, less than 2000 cP. Polyester polyols suitable for use in the polyurethane composites described herein can have a viscosity at 25° C. that is 1000 to 7000 cP, 1000 to 6000 cP, 1000 to 5000 cP, 1000 to 4000 cP, 2000 to 7000 cP, 2000 to 6000 cP, 2000 to 5000 cP, 2000 to 4000 cP, 3000 to 7000 cP, 3000 to 6000 cP, 3000 to 5000 cP, or 3000 to 4000 cP, The viscosity of the composite mixture can be measured using a Brookfield Viscometer.

The polyester polyol can be the reaction product of terephthalic acid or anhydride, a polyhydroxyl compound, and an alkoxylating agent, e.g. propylene oxide, as shown below:

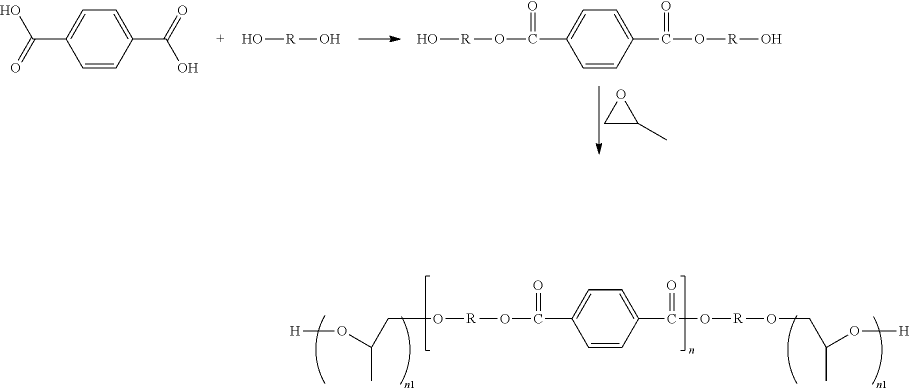

wherein R is branched or linear, saturated or unsaturated C2-10 alkyl, cycloalkyl, alkenyl, alkynal, aromatic, polyoxyethylenic, polyoxypropylenic; wherein R can contain pendant secondary functionality such as hydroxyl, aldehyde, ketone, ether, ester, amide, nitrile, amine, nitro, thiol, sulfonate, sulfate, and/or carboxylic groups; n can be from 1-200 and each n1 can independently be from 1-200. Where pendant secondary hydroxyl functionality is present, such hydroxyl groups can be alkoxylated.

Terephthalic acid or anhydride can be reacted with a polyol, i.e., a diol such as diethylene glycol to form an intermediate polyester polyol. This intermediate polyester polyol can then reacted be with an alkoxylating agent, such as propylene oxide, to form the polyester polyol.

The polyester polyol intermediates can be from the condensation of terephthalic acid or anhydride and ethylene glycol, diethylene glycol, propylene glycol, dipropylene glycol, neopentyl glycol, 1,4-butanediol, 1,6-hexanediol, polyethylene glycol, polypropylene glycol triethylene glycol, and tetramethylene glycol and mixtures thereof. The intermediate polyester polyol can be:

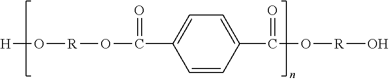

wherein R is a divalent radical selected from the group of: (a) alkylene radicals of about 2 to 10 carbon atoms; (b) radicals of the formula: —CH₂—R₂—CH₂— where R₂ is a radical selected from the group of:

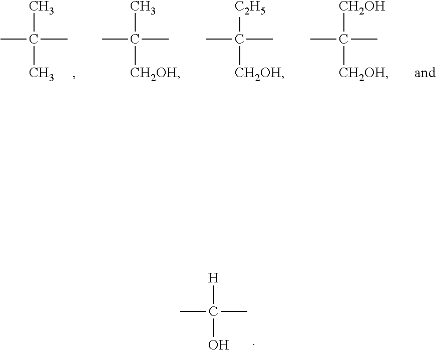

(c) radicals of the formula: —(R3O)z-R3- where R3 is an alkylene radical containing from about 2 to about 4 carbon atoms, and z is an integer of from 1 to 200; and wherein n is an integer from 1 to 200. The intermediate polyester polyol can be the polyester polyol used in the polyurethane. The polyester polyol can be the reaction product of phthalic acid or anhydride, a polyhydroxyl compound, and an alkoxylating agent, e.g. propylene oxide, as shown below:

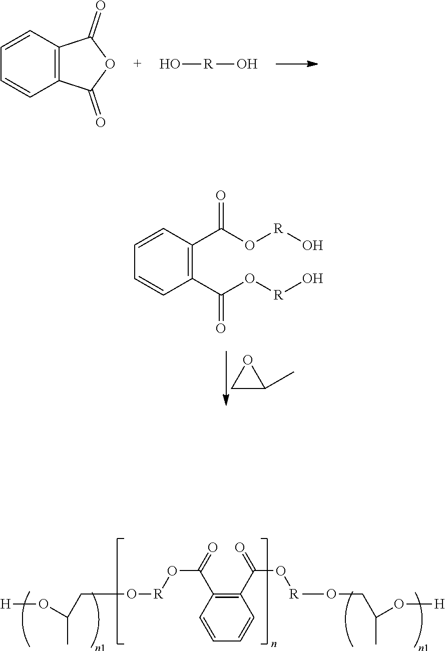

wherein R is branched or linear, saturated or unsaturated C2-10 alkyl, cycloalkyl, alkenyl, alkynl, aromatic, polyoxyethylenic, polyoxypropylenic; wherein R can contain pendant secondary functionality such as hydroxyl, aldehyde, ketone, ether, ester, amide, nitrile, amine, nitro, thiol, sulfonate, sulfate, and/or carboxylic groups; n can be from 1-200 and each n1 can independently be from 1-200. Where pendant secondary hydroxyl functionality is present, such hydroxyl groups can be alkoxylated.

Phthalic acid or anhydride can be reacted with a polyol, i.e., a diol such as diethylene glycol to form an intermediate polyester polyol. This intermediate polyester polyol can then reacted be with an alkoxylating agent, such as propylene oxide, to form the polyester polyol.

The polyester polyol intermediates can be from the condensation of phthalic acid or anhydride and ethylene glycol, diethylene glycol, propylene glycol, dipropylene glycol, neopentyl glycol, 1,4-butanediol, 1,6-hexanediol, polyethylene glycol, polypropylene glycol triethylene glycol, and tetramethylene glycol and mixtures thereof. The intermediate polyester polyol can be:

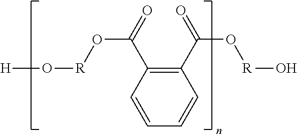

wherein R is a divalent radical selected from the group of: (a) alkylene radicals of about 2 to 10 carbon atoms; (b) radicals of the formula: —CH₂—R₂—CH₂— where R₂ is a radical selected from the group of:

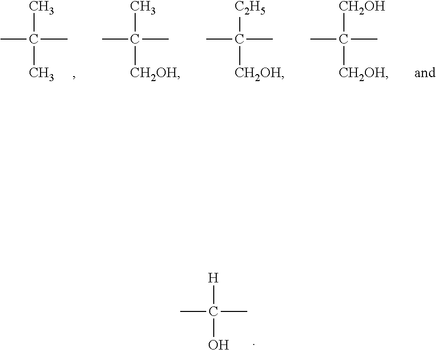

(c) radicals of the formula: —(R3O)z-R3- where R3 is an alkylene radical containing from about 2 to about 4 carbon atoms, and z is an integer of from 1 to 200; and wherein n is an integer from 1 to 200. The intermediate polyester polyol can be the polyester polyol used in the polyurethane.

The polyester polyol can be produced from phthalic acid-based material selected from the group consisting of phthalic anhydride, phthalic acid, isophthalic acid, terephthalic acid, methyl esters of phthalic, isophthalic, or terephthalic acid, dimethyl terephthalate, polyethylene terephthalate, trimellitic anhydride, pyromellitic dianhydride, maleic anhydride, or mixtures thereof.

The polyester polyol can be the reaction product of an aromatic dicarboxylic acid or anhydride, a polyhydroxyl compound, and an alkoxylating agent, e.g. propylene oxide. Further, for example, the polyester polyol can be the reaction product of an aromatic dicarboxylic acid or anhydride, an aliphatic fatty acid, such as a dibasic C9 to C34 fatty acid or derivative thereof, a polyhydroxyl compound, and an alkoxylating agent. The polyester polyol intermediates can be from the condensation of an aromatic dicarboxylic acid or anhydride and ethylene glycol, diethylene glycol, propylene glycol, dipropylene glycol, neopentyl glycol, 1,4-butanediol, 1,6-hexanediol, polyethylene glycol, polypropylene glycol triethylene glycol, and tetramethylene glycol and mixtures thereof. The aromatic dicarboxylic acid can be selected from the group of: phthalic acid, isophthalic acid, terephthalic acid, diphenic acid, and 2,6-naphthalenedicarboxylic acid. The aromatic dicarboxylic anhydride can be selected from the group of: phthalic anhydride, isophthalic anhydride, terephthalic anhydride, diphenic anhydride, and 2,6-naphthalenedicarboxylic anhydride.

The polymeric materials optionally may comprise one or more additional isocyanate-reactive monomers. When present, the additional isocyanate-reactive monomer(s) can be present in an amount of 30% or less, 25% or less, 20% or less, 15% or less, 10% or less, or 5% or less by weight, based on the weight of the one or more polyols. Exemplary isocyanate-reactive monomers include, for example, polyamines corresponding to the polyols described herein (e.g., a polyester polyol or a poly ether polyol), wherein the terminal hydroxyl groups are converted to amino groups, for example by amination or by reacting the hydroxyl groups with a diisocyanate and subsequently hydrolyzing the terminal isocyanate group to an amino group. For example, the polymeric mixture may comprise a poly ether polyamine, such as polyoxyalkylene diamine or polyoxyalkylene triamine.

In some embodiments, the mixture may comprise an alkoxylated polyamine (e.g., alkylene oxide-capped polyamines) derived from a polyamine and an alkylene oxide. Alkoxylated polyamines may be formed by reacting a suitable polyamine (e.g., monomeric, oligomeric, or polymeric polyamines) with a desired amount of an alkylene oxide. The polyamine may have a molecular weight less than 1000 g/mol, such as less than 800 g/mol, less than 750 g/mol, less than 500 g/mol, less than 250 g/mol, or less than 200 g/mol.

In some embodiments, the ratio of number of isocyanate groups to the total number of isocyanate reactive groups (e.g., hydroxyl groups, amine groups, and water) in the mixture is 0.5:1 to 1.5:1, which when multiplied by 100 produces an isocyanate index of 50 to 150. In some embodiments, the mixture may have an isocyanate index equal to or less than 140, equal to or less than 130, or equal to or less than 120. For example, with respect to a mixture used to prepare some polymers herein, the isocyanate index may be 80 to 140, 90 to 130, or 100 to 120. Further, for example, with respect to polyisocyanurate foams, the isocyanate index may be 180 to 380, such as 180 to 350 or 200 to 350.

The polymeric materials herein (e.g., polymeric foams) may be prepared with a catalyst, e.g., to facilitate curing and control curing times. Examples of suitable catalysts include, but are not limited to catalysts that comprise amine groups (including, e.g., tertiary amines such as 1,4-diazabicyclo[2.2.2]octane (DABCO), tetramethylbutanediamine, and diethanolamine) and catalysts that contain tin, mercury, or bismuth. The amount of catalyst in the mixture may be 0.01% to 2% based on the weight of the mixture used to prepare the polymer of the composite (e.g., the mixture comprising the isocyanate(s), the polyol(s), and other materials such as foaming agents, surfactants, chain-extenders, crosslinkers, coupling agents, UV stabilizers, fire retardants, antimicrobials, anti-oxidants, cell openers, and/or pigments). For example, the amount of catalyst may be 0.05% to 0.5% by weight, or 0.1% to 0.25% by weight, based on the weight of the mixture used to prepare the polymeric material. In some embodiments, the mixture may comprise between 0.05 and 0.5 parts per hundred parts of polyol.

The polymeric materials herein may comprise a filler material, such as an inorganic material. Examples of fillers useful for the polymeric material herein include, but are not limited to, fly ash, bottom ash, amorphous carbon (e.g., carbon black), silica (e.g., silica sand, silica fume, quartz), glass (e.g., ground/recycled glass such as window or bottle glass, milled glass, glass spheres and microspheres, glass flakes), calcium, calcium carbonate, calcium oxide, calcium hydroxide, aluminum, aluminum trihydrate, clay (e.g., kaolin, red mud clay, bentonite), mica, talc, wollastonite, alumina, feldspar, gypsum (calcium sulfate dehydrate), garnet, saponite, beidellite, granite, slag, antimony trioxide, barium sulfate, magnesium, magnesium oxide, magnesium hydroxide, aluminum hydroxide, gibbsite, titanium dioxide, zinc carbonate, zinc oxide, molecular sieves, perlite (including expanded perlite), diatomite, vermiculite, pyrophillite, expanded shale, volcanic tuff, pumice, hollow ceramic spheres, hollow plastic spheres, expanded plastic beads, ground tire rubber, cenospheres, or mixtures thereof.

In some embodiments, the filler may comprise an ash produced by firing fuels including coal, industrial gases, petroleum coke, petroleum products, municipal solid waste, paper sludge, wood, sawdust, refuse derived fuels, switchgrass, or other biomass material. For example, the filler may comprise a coal ash, such as fly ash, bottom ash, or combinations thereof. Fly ash is generally produced from the combustion of pulverized coal in electrical power generating plants. In some examples herein, the composite comprises fly ash selected from Class C fly ash, Class F fly ash, or a mixture thereof. In some embodiments, the functional filler consists of or consists essentially of fly ash.

The filler may have an average particle size greater than or equal to 5 μm and/or less than or equal to 800 μm. For example, at least a portion of the filler may have an average particle size of 100 μm to 700 μm, 200 μm to 600 μm, or 300 μm to 500 μm. Further, for example, the filler may have an average particle size of 5 pin to 100 μm, such as 10 pin to 50 μm or 20 μm to 40 μm. In some embodiments, the filler has an average particle size diameter of 100 μm or more, 150 μm or more, or 500 μm or more, e.g., between 100 μm and 450 μm or between 500 μm and 800 μm. In some embodiments, the filler has an average particle size of 500 μm or less, 400 μm or less, or 350 μm or less, e.g., between 50 μm and 450 μm or between 200 μm and 350 μm.

The filler can be present in the polymeric material in an amount up to 60% by weight, relative to the total weight of the polymeric material, such as up to 10% by weight, up to 15% by weight, up to 20% by weight, up to 25% by weight, up to 30% by weight, up to 35% by weight, up to 40% by weight, up to 45% by weight, up to 50% by weight, or up to 55% by weight. In some examples, the polymeric foam comprises 1% to 60% by weight of a filler, such as 1% to 5% by weight, 5% to 10% by weight, 10% to 15% by weight, 10% to 30% by weight, 20% to 50% by weight, or 40% to 50% by weight. In some examples, the polymeric foam comprises greater than zero and less than 10% by weight, less than 5% by weight, or less than 1% by weight of a filler material.

In some examples, the polymeric material comprises one or more fiber materials. The fiber materials can be any natural or synthetic fiber, based on inorganic or organic materials. Exemplary fiber materials include, but are not limited to, glass fibers, silica fibers, carbon fibers, metal fibers, mineral fibers, organic polymer fibers, cellulose fibers, biomass fibers, and combinations thereof.

The polymeric materials herein may comprise at least one additional material, such as, e.g., foaming agents, surfactants, chain-extenders, crosslinkers, coupling agents, UV stabilizers, fire retardants, antimicrobials, anti-oxidants, cell openers, and/or pigments. The polymeric materials may be prepared as a foam using chemical blowing agents, physical blowing agents, or a combination thereof. If a blowing agent is present in the polymeric material, the amount of blowing agent may be present in an amount of less than 1 part per hundred, relative to the total weight of the polymeric material.

According to some aspects of the present disclosure, the density of the polymeric foam is less than or equal to 5 pcf, such as 1 pcf to 5 pcf, 2 pcf to 5 pcf, 3 pcf to 5 pcf, or 1 pcf to 3 pcf. In some examples, the density of the polymeric foam is less than or equal to 2 pcf or less than or equal to 1 pcf.

As mentioned above, the structural support may comprise a polymer, fiber, metal, or combination thereof. In some embodiments of the present disclosure, the structural support comprises a polymer, and the composition of the structural support is the same or different than the composition of the polymeric foam. For example, both the structural support and the polymeric foam may comprise polyurethane, polyvinylchloride, polypropylene, polyethylene, polyethylene terephthalate, polyamide, polystyrene, acrylonitrile butadiene styrene, polycarbonate, polyethylenimine, or a combination thereof, optionally with other components such as a filler material. In some examples, the structural support comprises a polymer different from the polymer of the polymeric foam. For example, the structural support defining a plurality of cavities may comprise a first polymeric material (optionally in the form of a foam), and the cavities of the structural support may be at least partially filled with a second polymeric material in the form of a foam. In at least one example, the polymeric foam comprises polyurethane, and the structural support comprises a polymer other than polyurethane.

The structural support and polymeric foam are present in the composite material in relative amounts such as that the composite material has an optimal density and compressive strength. The structural support and polymeric foam may be present in a weight ratio of 1:20 to (structural support:polymeric foam), such as 1:10 to 10:1, 1:5 to 5:1, 1:2 to 2:1, or 1:1.

Polymeric foams according to the present disclosure may be prepared using chemical blowing agents, physical blowing agents, or a combination thereof. The composite materials herein or a portion thereof may be prepared by free rise foaming or by extrusion.

In the case of free rise foaming, a polymer mixture is typically added to a mold and set aside to allow the mixture to foam. The resulting composite materials can then be cut into a desired shape and/or size, such as sheets or large blocks generally referred to as buns or foam buns. In some embodiments, the foaming may be in a mold or in situ. For instance, the foaming may occur adjacent to a mold surface or a building surface, such that a portion of the foam cell structure contacting such surface compresses or collapses. A portion of the foam cell structure compressed or collapsed may form a skin structure. In the case of extrusion, the mixture may be passed through a vessel of a continuous conveyer system, wherein the mixture foams and is shaped through contact with the walls of the vessel. In both cases, formation of the composite materials may be characterized in terms of the cream time, referring to the time at which the mixture starts to foam or expand, and the tack free time, referring to the period from the start of cure/foaming to a point when the material is sufficiently robust to resist damage by touch or settling dirt.

In an example according to the present disclosure, a pre-formed structural support having a plurality of cavities is combined with a polymer mixture comprising a blowing agent, such that the polymer mixture foams to partially or completely fill the cavities. For example, the structural support may be placed in a mold, optionally using one or more spacers to provide space between the structural support and the mold surface. The polymer mixture then may be added to the mold and allowed to foam and fill the spaces between the structural support and the mold. Alternatively, the polymer mixture may be added to the mold and the structural support then added while the polymer mixture forms a foam to fill the cavities of the structural support.

In some embodiments, the structural support may be formed in situ. For example, the structural support may comprise a polymeric material, e.g., polyurethane, polyvinylchloride, polypropylene, polyethylene, polyethylene terephthalate, polyamide, polystyrene, acrylonitrile butadiene styrene, polycarbonate, polyethylenimine, or a combination thereof. The polymeric material may be foamed, e.g., with the use of a blowing agent, into a desired 3D shape or into an initial form that then may be manipulated into the desired 3D shape. For example, the structural support may be prepared using pinch-roller thermoforming, thermoform stamping, a folding process, a shaping process, a bonding process, a laminating process, or a combination thereof. The bonding process may be a continuous or discontinuous skin bonding process, wherein a skin forms integrally with the structural support. Additionally or alternatively, a skin or coating may be applied to one or more surfaces of the structural support. The coating can be a sealant, can be waterproof, and/or can increase the durability or strength of the building product. In some examples, the coating may comprise a polymeric material, e.g., polymeric cement, polyurethane, polyvinylchloride, polypropylene, polyethylene, polyethylene terephthalate, polyamide, polystyrene, acrylonitrile butadiene styrene, polycarbonate, or polyethylenimine, fiber mesh, fillers, or mixtures thereof.

A polymer mixture comprising a blowing agent then may be added to the structural support (or vice-versa), such that the polymer mixture foams to fill the cavities of the structural support. In a least one example, the polymer mixture comprises an isocyanate, a polyol, and an inorganic filler to form a polyurethane foam. In at least one example, the polymer mixture comprises polyvinylchloride (e.g., heated to melt the polymer and combined with a suitable blowing agent for foaming) to form a polyvinylchloride foam.

As mentioned above, the polymeric foam may be prepared using a prepolymer mixture. For example, the prepolymer mixture may comprise an isocyanate and a polyol. The isocyanate may be an isomer, such as monomeric 4,4′-MDI, and optionally may be combined with polymeric MDI. The relatively higher reactivity of monomeric MDI and relatively high viscosity of the prepolymer mixture may assist in controlling the foaming process. Optionally, the polyol(s) may include one or more hydrophobic polyols as discussed above. In some examples, the prepolymer is devoid of water (e.g., to avoid premature reaction between water and the relatedly more reactive monomeric MDI). The prepolymer may help to control reactivity of components and/or viscosity of the mixture to promote capture of gas(es) released (e.g., CO₂ and/or gaseous blowing agent), allowing for preparation of lower density composite materials. For example, gel formation and foam formation may take place more closely together in time when using a prepolymer mixture. According to some examples, the absence of free polyols in the formulation also may assist in forming lower density materials. Capture of gases during formation of the foam may result in more and/or larger entrapped gas cells, thus leading to an increase in volume for similar mass and hence lower density.

The polyol(s) and isocyanate may be present in the prepolymer mixture in a weight ratio of about 1:4 to about 1:2 (polyol:isocyanate), for example, about 1:3. Pre-polymerized urethane linkages in the prepolymer mixture may provide for a relatively viscous fluid form. The viscosity of the prepolymer mixture may range from 1,000 cps to 50,000 cps. For example, the viscosity of the prepolymer mixture may range from 1,000 cps to 45,000 cps, 1,000 cps to 40,000 cps, 1,000 cps to 35,000 cps, 1,000 cps to 30,000 cps, 1,000 cps to 25,000 cps, 1,000 cps to 20,000 cps, 1,000 cps to 15,000 cps, 1,000 cps to 10,000 cps, 5,000 cps to cps, or 5,000 cps to 10,000 cps. The prepolymer may be prepared and optionally stored for later use, for example several hours to several days later.

The prepolymer mixture then may be mixed with other components to form a polymer mixture, wherein the other components may include one or more polyols, which may be the same or different than the polyol of the prepolymer mixture, water, surfactant, catalyst, filler(s), and/or one or more blowing agents. Upon addition of surfactant, catalyst and water, optionally with additional free polyol (hydrophobic or not) the polymer mixture may gel and foam by the generation of CO₂ through reaction of water and isocyanate. If physical/auxiliary blowing agent(s) are added, the reaction may generate gas (e.g., due to foam exothermic heat generation) in addition to the CO₂ gas generated from the MDI-water reaction. Use of such physical/auxiliary blowing agents may be desirable to provide for further decreases in density, e.g., by additional evolved gas captured within the polymer matrix. The rate of foaming may be controlled by the rate and manner at which the water is released into the system. Methods of using a prepolymer may provide for a controllable blowing reaction, CO₂ formation and polyurea formation with no urethane, e.g., as opposed to multiple simultaneous gelling and blowing reactions. Further, the methods herein provide additional flexibility, e.g., to change reactivity by altering the functionality of monomeric/polymeric isocyanate ratios.

In some examples, the structural support and the polymer mixture may be combined in a closed mold. The composite material may be prepared with any desired dimensions. For example, the composite material may be prepared in a mold of suitable dimensions and/or the composite material may be cut to the desired length, width, and thickness (depth). The composite material may have a length ranging from 1 inch to 8 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet. The composite material may have a width ranging from 1 inch to 8 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet.

The composite material may have a thickness (depth) ranging from 0.25 inches (6.35 mm) to 4 inches (101.6 mm), such as 0.25 inches to 3 inches, 0.50 inches to 2.75 inches, inches to 2.50 inches, or from 1 inch to 2.25 inches. As mentioned above, spacers of suitable thickness may be used to provide the desired depth of the composite material. The spacers may have a thickness of, for example, 0.25 inches, 0.50 inches, or 0.75 inches, to produce composite materials with a thickness of, for example, 0.75 inches, 0.50 inches, or 0.25 inches, respectively. In some examples, the thickness of the composite material may correspond to the thickness of the structural support.

In a non-limiting example, the composite material is about 6 inches in width, about 6 inches in length, and about 1.25 inches in thickness.

The structural support may have a desired length, width, and thickness. The structural support may have a length ranging from 1 inch to 3 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet. The structural support may have a width ranging from 1 inch to 3 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet. The structural support may have a thickness (depth) ranging from mm to 65 mm, for example, from 0.25 mm to 60 mm, 0.25 mm to 50 mm, 0.25 mm to mm, 0.25 mm to 30 mm, 0.25 mm to 20 mm, 0.50 mm to 10 mm, 0.50 mm to 20 mm, mm to 30 mm, 0.50 mm to 40 mm, 0.50 mm to 50 mm, or 0.50 mm to 60 mm.

In some examples, a polymeric material may be poured into a mold to fill the cavities of the structural support, e.g., covering the upper surface, lower surface, and side surfaces of the structural support. The mold then may be closed and optionally heated, for example, at a temperature of about 60° C. After heating for approximately 2 hours, the mold is removed from the oven and the composite material is demolded. The composite material may include a skin or coating integrally formed on one or more surfaces of the composite material and/or a coating may be applied to one or more surfaces of the composite material after filling the cavities of the structural support with the polymeric foam.

As mentioned above, an exemplary composite material is shown in FIG. 2 alongside an unfilled support structure (before addition of polymeric foam) and a sample of polymeric foam for comparison. In the composite material, the polymeric foam fills the triangular cavities of the support structure to form a generally rectangular or square material. Optionally, the composite material may be cut to a desired shape and/or size.

The composite materials have a low or relatively low density. For example, the composite materials may have an average density of 20 pcf or less, such as 1 pcf to 20 pcf, e.g., 2 pcf to 15 pcf, 2 pcf to 10 pcf, 3 pcf to 10 pcf, 2 pcf to 6 pcf, or 3 pcf to 6 pcf (1 pcf=16.0 kg/m 3). In some examples, the composite materials may have an average density greater than or equal to 2 pcf, greater than or equal to 4 pcf, greater than or equal to 6 pcf, and/or less than or equal to 20 pcf, less than or equal to 15 pcf, or less than or equal to 10 pcf.

The building materials herein may have water-repellant, water-resistant, or waterproof characteristics. Moisture movement measurements may provide an indication of the water resistance of a building material. The moisture movement is calculated as the change in length based on the length of the dried sample (L)_{d} and the length of the samples after being submerged in water (L)ₛ.

$$Moisture movement ( length ) , \% = \frac{[ {( L )}_{s} ‐ {( L )}_{d} ] \times 100}{{( L )}_{d}}$$

The water uptake is calculated as the change in weight based on the weight of the dried sample (W)_{d} and the weight of the samples after being submerged in water (W)ₛ.

$$Water uptake ( mass ) , \% = \frac{[ {( W )}_{{s}^{-}} {( W )}_{d} ] \times 100}{{( W )}_{d}}$$

The “moisture movement” and “water uptake” for the purposes of the present disclosure are measured according to the following procedure, unless otherwise specified: Samples are collected and inspected using the protocols described in Section 4 of ASTM C1185-08(2016), unless otherwise specified. Cut the samples to a length of 6 inches and a width≤12 inches and a thickness≤1 inch. Dry each sample to constant weight in a ventilated oven at a temperature of 90±2° C. and cool to room temperature in a desiccator or desiccator-type cabinet. Measure the length of each sample in a dial gage comparator using a standard bar of the same nominal length as the specimen for reference, or any other method capable of measuring each specimen to the nearest 0.001 in. (0.02 mm). Weigh each cooled sample separately on a scale of an accuracy of 0.5% of sample mass. Submerge the samples for 14 days, 21 days, 30 days, or days in distilled water at 45±4° C. or 23±4° C. Remove each sample from the water, wipe each sample with a dry cloth. Weigh each sample separately on a scale of an accuracy of 0.5% of sample mass. Measure the length of each specimen in a dial gage comparator or any other method capable of measuring each specimen to the nearest 0.001 in. (0.02 mm). If bowing is evident, choose a method that will record measurements on both sides of the test specimen and average the results.

The moisture movement (length) of a sample of the polyurethane composite and/or polyurethane foam having a length of 6 inches can be less than 0.8%, less than 0.7%, or less than 0.6%. For example, the moisture movement (length) of the polyurethane composite and/or polyurethane foam can be from 0.2% to 0.8%, or from 0.30% to 0.60%. Further, for example, the moisture movement (width) of the polyurethane composite and/or polyurethane foam having a length of 6 inches can be less than 0.9%, less than 0.8%, less than 0.7%, less than or less than 0.5%. For example, the moisture movement (width) of the polyurethane composite and/or polyurethane foam can be from 0.2% to 0.9%, 0.2% to 0.7%, or 0.2% to 0.4%. The moisture movement (thickness) of the polyurethane composite and/or polyurethane foam having a length of 6 inches can be less than 1.2%, less than 1.0%, or less than 0.8%. For example, the moisture movement (thickness) of the polyurethane composite and/or polyurethane foam can be from 0.2% to 1.2%, or 0.5% to 0.8%.

Hydrophobicity of the building materials and structural supports and polymeric foams thereof may be reflected at least partially in contact angle measurements. In general, hydrophobic materials are known as non-polar materials with a low affinity to water, which makes them water-repelling. Hydrophobic materials prefer neutral molecules and non-polar solvents. Because water molecules are polar, hydrophobic materials do not intermingle or mix well with them. Hydrophobic surfaces exhibit higher water contact angles. A contact angle of greater than 90° indicates a hydrophobic interaction. According to some aspects of the present disclosure, the building material may have a water contact angle greater than 90°, for example from 90° to 130°, 100° to 125°, 105° to 120°, 110° to 115°, or 120° to 125°. Further, for example, the structural support and/or polymeric foam may have a water contact angle greater than 90°, for example from 90° to 130°, 100° to 125°, 105° to 120°, 110° to 115°, or 120° to 125°. Optionally, the structural support may include a water-resistant or waterproof coating. In some examples, the structural support and/or building material comprising the structural support does not include a coating (e.g., water-resistant or waterproof coating) and has a water contact angle greater than 90°, for example from 90° to 130°, 100° to 125°, 105° to 120°, 110° to 115°, or 120° to 125°.

The composite materials herein may have a compressive strength greater than or equal to 20 psi (145.0 psi=1 MPa), greater than or equal to 30 psi, greater than or equal to psi, greater than or equal to 50 psi, greater than or equal to 60 psi, greater than or equal to psi, greater than or equal to 80 psi, or equal than or equal to 90 psi, e.g., 20 psi to 200 psi, psi to 150 psi, 50 psi to 100 psi, 120 psi to 150 psi, or 75 psi to 125 psi. Compressive strength can be measured by the stress measured at the point of permanent yield, zero slope, on the stress-strain curve as measured according to ASTM D695-15.

Additionally or alternatively, the composite materials may have a flexural strength greater than or equal to 5 psi, greater than or equal to 10 psi, greater than or equal to psi, greater than or equal to 100 psi, greater than or equal to 200 psi, greater than or equal to 300 psi, greater than or equal to 400 psi, and/or less than or equal to 500 psi, less than or equal to 400 psi, less than or equal to 300 psi, less than or equal to 200 psi, or less than or equal to 100 psi. Flexural strength can be measured as the load required to fracture a rectangular prism loaded in the three point bend test as described in ASTM C1185-08 (2012), wherein flexural modulus is the slope of the stress/strain curve.

The composite materials may have a modulus of elasticity (stiffness) greater than or equal to 10 psi, greater than or equal to 100 psi, greater than or equal to 200 psi, greater than or equal to 300 psi, greater than or equal to 400 psi, greater than or equal to 500 psi, or greater than or equal to 600 psi, greater than or equal to 700 psi, greater than or equal to 800 psi, greater than or equal to 900 psi, or greater than or equal to 1000 psi. The modulus of elasticity can be from 10 psi to 1000 psi, 100 psi to 1000 psi, 200 psi to 1000 psi, 300 psi to 1000 psi, 400 psi to 1000 psi, or 500 psi to 1000 psi. The modulus of elasticity can be determined as described in ASTM C947-03.

The composite materials may have high anisotropic strength. Anisotropic strength refers to the compressive strength of the composite materials in different directions, e.g., along the thickness, along the length, and/or along the width. The composite materials herein may have an anisotropic strength ratio of at least 3:1, in the direction of thickness to length or thickness to width, e.g., greater than or equal to 5:1, or greater than or equal to 10:1. For example, the composite materials may have an anisotropic strength ratio of 3:1 to 50:1, 5:1 to or 10:1 to 20:1.

The composite materials herein may combine low density with desired compressive strength, such that the composite may be suitable for use in building products. For example, the composite materials herein may have compressive strength and/or other mechanical properties comparable to materials such as plywood, particle board, and other wood- or fiber-based materials.

The composite materials herein may be used for any desirable type of building product. For example, the composite materials may be used in place of other materials such as lumber, structural sheet products, plywood, panels, backer boards, etc.

The composite materials herein can be prepared with any desired dimensions or shapes. According to some aspects of the present disclosure, the composite may be prepared as a flat sheet (e.g., in rectangular shape having a length, a width, and a thickness, as detailed above). A person of ordinary skill in the art will recognize that the composite materials need not be prepared in sheet-like form and other dimensions and shapes than those provided above are encompassed herein.

While principles of the present disclosure are described herein with reference to illustrative aspects for particular applications, the disclosure is not limited thereto. Those having ordinary skill in the art and access to the teachings provided herein will recognize additional modifications, applications, aspects, and substitution of equivalents that all fall in the scope of the aspects described herein. Accordingly, the present disclosure is not to be considered as limited by the foregoing description.

### EXAMPLES

The following examples are intended to illustrate the present disclosure without being limiting in nature. It is understood that the present disclosure encompasses additional embodiments consistent with the foregoing description and following examples.

### Example 1

The following materials were prepared by mixing an aromatic polyester polyol with an isocyanate (polymeric MDI), and different amounts of water and a low boiling point liquid hydrocarbon blowing agent according to Table 1 to form a polymer mixture. Two of the polymer mixtures (Composites 1 and 2) were each combined with a structural support having multiple cavities (e.g., a honeycomb structure) and allowed to free rise to form a polyurethane foam within the cavities. The third polymer mixture was allowed to free rise to form a polyurethane foam, without structural support (PU Foam).

TABLE 1

| | | HC Liquid | Presence of | | |
|---|---|---|---|---|---|
| | | Blowing | Structural | | Compressive |
| Polymer | Water | Agent | Support | Density | Strength |
| Mixture | (pphp) | (pphp) | (Y/N) | (pcf) | (psi) |
| Composite 1 | 8 | 20 | Y | 2.9 | 61.3 |
| Composite 2 | 6 | 0 | Y | 3.5 | 66.0 |
| PU Foam | 6 | 20 | N | 3.5 | 32.0 |

The compressive strength of the structural support alone was measured at 18 psi. The compressive strength and density measured for the respective materials are reported in Table 1. The results show that the combination of a structural support and polyurethane foam successfully produced composite materials with a low or relatively low density (e.g., similar to polyurethane foam without a structural support) and higher compressive strength than the polyurethane foam alone.

### Example 2

A composite material (Composite 3) was prepared using two different isocyanates—a polymeric isocyanate and an isomeric isocyanate. A polymer mixture was prepared by combining a hydrophobic polyol with polymeric methylene diphenyl diisocyanate (MDI), monomeric 4,4′-MDI, fly ash (Class C) as filler, water, and a low boiling point liquid hydrocarbon blowing agent according to Table 2. The polymer mixture was allowed to free rise to form a polyurethane composite with the properties reported in Table 3.

TABLE 2

| | | | | | | HC Liquid |
|---|---|---|---|---|---|---|
| | | | 4,4′- | | | Blowing |
| Polymer | Polyol | Polymeric | MDI | Filler | Water | Agent |
| Mixture | (g) | MDI (g) | (g) | (% wt) | (g) | (pphp) |
| Composite 3 | 20.78 | 12.55 | 5.65 | 73 | 0.72 | 0.72 |

TABLE 3

| | | Flexural | Compressive | Moisture |
|---|---|---|---|---|
| | Density | strength | strength | Movement |
| | (pcf) | (psi) | (psi) | (%) (21 days) |
| Composite 3 | 43 | 1690 | 314 | 0.20 |

### Example 3

Polyurethane foams were prepared using the same single pot approach described in Example 2 (PU Foams 1A and 1B), and by first preparing a prepolymer mixture (PU Foams 2A and 2B).

In the single pot approach, polymer mixtures were prepared by combining a hydrophobic polyol with polymeric MDI, monomeric 4,4′-MDI, water, and a low boiling point liquid hydrocarbon blowing agent, according to Table 4. Different hydrophobic polyols were used for PU Foam 1A and PU Foam 1B.

TABLE 4

| | | Polymeric | 4,4′- | | HC Liquid |
|---|---|---|---|---|---|
| Polymer | Polyol | MDI | MDI | Water | Blowing Agent |
| Mixture | (g) | (g) | (g) | (g) | (pphp) |
| PU Foam 1A | 18.38 | 12.94 | 5.87 | 0.31 | 0.31 |
| PU Foam 1B | 20.78 | 12.55 | 5.65 | 0.72 | 0.72 |

In the corresponding prepolymer approach, prepolymer mixtures were first prepared by combining a hydrophobic polyol with monomeric 4,4′-MDI, according to Table 5. The same hydrophobic polyol used for PU Foam 1A was used in PU Foam 2A, and the same hydrophobic polyol used for PU Foam 1B was used in PU Foam 2B. The prepolymer mixtures were then combined with more of the same hydrophobic polymer, polymeric MDI, water, and a low boiling point liquid hydrocarbon blowing agent according to Table 6 to form polymer mixtures.

TABLE 5

| Prepolymer Mixture | Polyol (g) | 4,4′-MDI |
|---|---|---|
| Prepolymer for PU Foam 2A | 40.0 | 125.0 |
| Prepolymer for PU Foam 2B | 45.0 | 125.0 |

TABLE 6

| | | Pre- | Polymeric | | HC Liquid |
|---|---|---|---|---|---|
| Polymer | Polyol | polymer | MDI | Water | Blowing Agent |
| Mixture | (g) | (g) | (g) | (g) | (pphp) |
| PU Foam 2A | 15.62 | 8.63 | 12.94 | 0.31 | 0.31 |
| PU Foam 2B | 17.60 | 8.83 | 12.55 | 0.72 | 0.72 |

The polymer mixtures were allowed to free rise to form polyurethane foams with the properties reported in Table 7. The polyurethane foams had similar densities, compressive strength, and moisture movement properties.

TABLE 7

| | | Compressive | Moisture |
|---|---|---|---|
| | Density | Strength | Movement |
| | (pcf) | (psi) | (%) (21 days) |
| PU Foam 1A | 3.73 | 63.6 | 0.28 |
| PU Foam 1B | 2.72 | 52.6 | 0.24 |
| PU Foam 2A | 3.03 | 61.4 | 0.21 |
| PU Foam 2B | 2.40 | 51.8 | 0.19 |

### Example 4

The following composite materials were prepared to investigate different types of support structures combined with polymer foams with different types of fillers. Polyurethane composite foams were prepared using the single pot approach described in Examples 2 and 3 according to Table 8. Composite materials were prepared without a structural support (Composites 5, 6, and 7), with an untreated structural support (Composites 8, 9, and 10), and with a structural support treated with a fluorinated hydrophobic coating (Composites 11 and 12). Class C fly ash was used as the filler for Composites 5, 8, and 11; Class F fly ash was used as the filler for Composites 6, 9, and 12, and polyash dust was used as the filler for Composites 7 and 10. Each structural support was formed of paper/cardboard in a honeycomb structure having multiple cavities. The composite materials were prepared by adding the polymeric mixture of Table 8 with the respective structural supports and allowing the mixtures to free rise to form polyurethane foams within the cavities.

TABLE 8

| | | | 4,4′- | | | HC Liquid |
|---|---|---|---|---|---|---|
| | Polyol | Polymeric | MDI | Filler | Water | Blowing Agent |
| | (g) | MDI (g) | (g) | (% wt) | (g) | (pphp) |
| Polymer | 20.78 | 12.55 | 5.65 | 73 | 0.72 | 0.72 |
| Mixture | | | | | | |

TABLE 9

| | | | | | | Moisture |
|---|---|---|---|---|---|---|
| | | | | Flexural | Compressive | Movement |
| | | Structural | Density | strength | strength | (%) (21 |
| | Filler | Support | (pcf) | (psi) | (psi) | days) |
| Composite 5 | Class C FA | N | 44 | 1700 | 340 | 0.14 |
| Composite 6 | Class F FA | N | 45 | 1835 | 365 | 0.11 |
| Composite 7 | Polyash dust | N | 46 | 1754 | 302 | 0.21 |
| Composite 8 | Class C FA | Y—untreated | 46 | 2040 | 485 | 0.10 |
| Composite 9 | Class F FA | Y—untreated | 47 | 2287 | 562 | 0.07 |
| Composite 10 | Polyash dust | Y—untreated | 48 | 2010 | 492 | 0.17 |
| Composite 11 | Class C FA | Y—treated | 46 | 2102 | 497 | 0.08 |
| Composite 12 | Class F FA | Y—treated | 47 | 2305 | 586 | 0.06 |

The results show that the various composite materials had similar densities, and relatively high compressive strength and flexural strength values. The composite materials having a structural support exhibited higher flexural strength and compressive strength, without significant increase in density relative to the composite materials without supports. The composite materials with structural supports also exhibited lower moisture movement characteristics, with the treated supports exhibiting lower moisture movement characteristics for comparable polyurethane foam chemistry. The materials incorporating Class F fly ash had lower moisture movement characteristics relative to those using Class C fly ash, which is attributed to Class F fly ash generally having a higher content of pozzolanic compounds.

It is intended that the specification and examples be considered as exemplary only, with a true scope and spirit of the present disclosure being indicated by the following claims.

What is claimed is:

1. A building material comprising:
a structure having a plurality of cavities; and
a polymeric foam filling a portion of the plurality of cavities;
wherein the polymeric foam comprises hydrophobic polyurethane foam having a density less than 5 pcf; and
wherein the structure comprises a hydrophobic polymer.

2. The building material of claim 1, wherein a sample of the composite material having a length of 6 inches has a moisture movement of less than or equal to 1.0% along the length when submerged in 46° C. distilled water for 10 days.

3. The building material of claim 2, wherein water uptake by the sample is less than 20.0 wt % when submerged in 46° C. distilled water for 10 days.

4. The building material of claim 1, wherein the structure has a thickness of about mm to about 100 mm.

5. The building material of claim 1, wherein the polymeric foam comprises an inorganic filler.

6. The building material of claim 1, wherein the cavities of the structure have a circular or polygonal shape.

7. The building material of claim 1, wherein the composite material has a generally rectangular shape with a thickness of about 0.25 inches to about 3 inches.

8. A building material comprising:
a structure having a plurality of cavities, the structure comprising a first polymeric foam; and
a second polymeric foam filling the plurality of cavities;
wherein the composite material has an average density less than 20 pcf; and
wherein the composite material has a compressive strength of at least 60 psi.

9. The building material of claim 8, wherein each of the first polymeric foam and the second polymeric foam is hydrophobic.

10. The building material of claim 8, wherein the first polymeric foam has a different chemical composition than the second polymeric foam.

11. The building material of claim 8, wherein the second polymeric foam has a density less than 5 pcf.

12. The building material of claim 8, wherein a surface of the building material comprises a layer of a waterproof sealant, a layer of a cementitious material, a polymeric facer, or a combination thereof.

13. A method of preparing a building material, the method comprising:
preparing a structure having a plurality of cavities, the structure comprising a first polymeric material; and
covering the structure with a polymer mixture comprising a blowing agent, such that the polymer mixture foams to fill the cavities with a second polymeric material;
wherein the building material has an average density less than 15 pcf.

14. The method of claim 13, wherein the polymer mixture comprises a polyester polyol derived from phthalic anhydride; phthalic acid; isophthalic acid; terephthalic acid; methyl esters of phthalic, isophthalic, or terephthalic acid; dimethyl terephthalate; polyethylene terephthalate; trimellitic anhydride; pyromellitic dianhydride; maleic anhydride; or mixtures thereof.

15. The method of claim 13, wherein the polymer mixture comprises monomeric methylene diphenyl diisocyanate.

16. The method of claim 15, wherein the polymer mixture further comprises polymeric methylene diphenyl diisocyanate.

17. The method of claim 15, wherein the polymer mixture further comprises a surfactant and a catalyst.

18. The method of claim 13, further comprising preparing the polymer mixture by combining monomeric methylene diphenyl diisocyanate with a hydrophobic polyol to produce a prepolymer mixture, and then combining the prepolymer mixture with the blowing agent.

19. The method of claim 18, wherein the prepolymer mixture has a viscosity of 5,000 cps to 15,000 cps.

20. The method of claim 13, wherein the structure is covered with the polymer mixture in a closed mold.
